(19) United States
(12) Patent Application Publication
(10) Pub. No.: US 2024/0221237 A1
(43) Pub. Date: Jul. 4, 2024

(54) CONTROL APPARATUS

(71) Applicant: TOYOTA JIDOSHA KABUSHIKI KAISHA, Aichi-ken (JP)

(72) Inventor: Tatsuro HORI, Edogawa-ku (JP)

(21) Appl. No.: 18/542,768

(22) Filed: Dec. 18, 2023

(30) Foreign Application Priority Data
Dec. 28, 2022 (JP) 2022-212666

(51) Int. Cl. G06T 11/00; G06T 7/70

(52) U.S. Cl. CPC G06T 11/00; G06T 7/70; G06T 2207/10016; G06T 2207/30196

(57) ABSTRACT

A control apparatus includes a controller. The controller is configured to determine an image to be preferentially superimposed on one or more other images, based on a situation of a first user or a situation of a second user facing a display, when two or more images out of an image of the first user, an image of the second user, and an image of a predetermined object are superimposed and displayed on the display.

### CROSS-REFERENCE TO RELATED APPLICATION

This application claims priority to Japanese Patent Application No. 2022-212666 filed on Dec. 28, 2022, the entire contents of which are incorporated herein by reference.

### TECHNICAL FIELD

The present disclosure relates to a control apparatus.

### BACKGROUND

Technology for generating a video in which multiple images are superimposed is known. For example, Patent Literature (PTL) 1 describes generating a superimposed video in which a first virtual object and an adjusted second virtual object are superimposed.

### CITATION LIST

### Patent Literature

PTL 1: WO 2021/230101 A1

### SUMMARY

Conventional technology has room for improvement. For example, the image that should be on top among multiple images may change depending on the situation of the user, or the like, visually recognizing the video.

It would be helpful to provide improved technology for generating a video in which multiple images are superimposed.

A control apparatus according to an embodiment of the present disclosure includes a controller configured to determine an image to be preferentially superimposed on one or more other images, based on a situation of a first user or a situation of a second user facing a display, when two or more images out of an image of the first user, an image of the second user, and an image of a predetermined object are superimposed and displayed on the display.

According to an embodiment of the present disclosure, improved technology for generating a video in which multiple images are superimposed can be provided.

### BRIEF DESCRIPTION OF THE DRAWINGS

In the accompanying drawings:

FIG. 1 is a block diagram of a system according to an embodiment of the present disclosure;

FIG. 2 is a flowchart illustrating an operation procedure of a terminal apparatus illustrated in FIG. 1;

FIG. 3 is a flowchart illustrating an operation procedure of the terminal apparatus illustrated in FIG. 1; and

FIG. 4 is a diagram illustrating an example of a two-dimensional image displayed on a display of the terminal apparatus illustrated in FIG. 1.

### DETAILED DESCRIPTION

An embodiment of the present disclosure will be described below, with reference to the drawings.

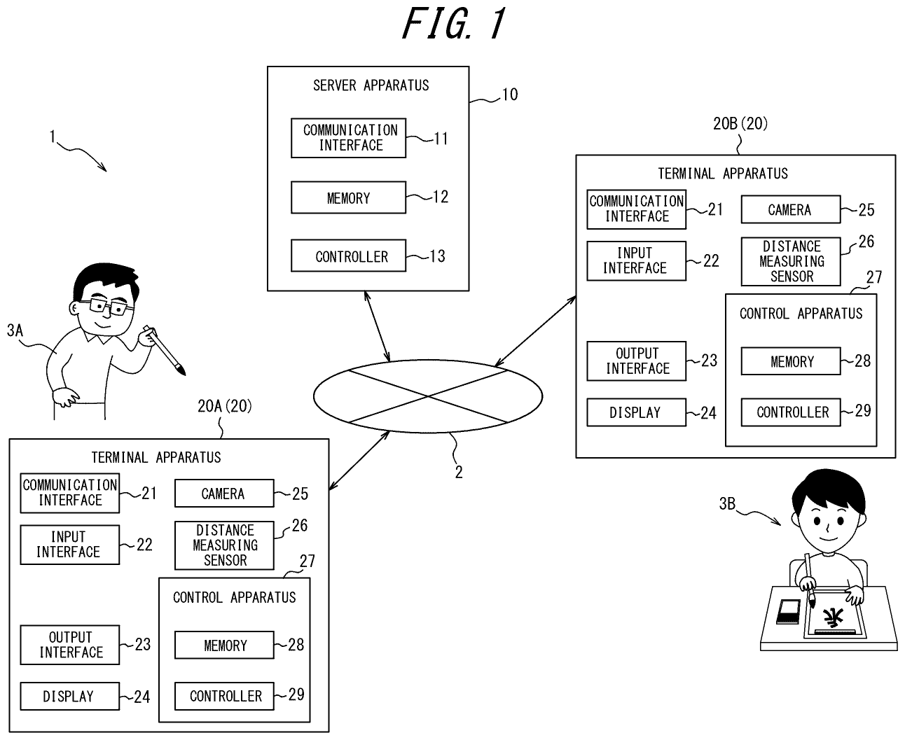

As illustrated in FIG. 1, a system 1 includes at least one server apparatus 10, a terminal apparatus 20A, and a terminal apparatus 20B. Hereinafter, the terminal apparatuses 20A and 20B are also collectively referred to as “terminal apparatuses 20” unless particularly distinguished. The system 1 includes two terminal apparatuses 20. However, the system 1 may include two or more terminal apparatuses 20.

The server apparatus 10 can communicate with the terminal apparatuses 20 via a network 2. The network 2 may be any network including a mobile communication network, the Internet, or the like.

The system 1 is a system for providing virtual events. The virtual events are provided using the virtual space. The system 1 according to the present embodiment provides a learning curve by offering the virtual events.

The server apparatus 10 is, for example, a server computer that belongs to a cloud computing system or other computing system and functions as a server that implements various functions.

The server apparatus 10 performs processing required for provision of a virtual event. For example, the server apparatus 10 transmits information required for provision of the virtual event to the terminal apparatuses 20 via the network 2. The server apparatus 10 also intermediates transmission and reception of information between the terminal apparatuses 20A and 20B during the virtual event.

The terminal apparatus 20A is used by a first user 3A. The first user 3A participates in the virtual event using the terminal apparatus 20A. The first user 3A is a calligraphy teacher. The first user 3A is, for example, an adult. The first user 3A faces the display 24 of the terminal apparatus 20A. The first user 3A teaches calligraphy to the second user 3B.

The terminal apparatus 20B is used by a second user 3B. The second user 3B participates in the virtual event using the terminal apparatus 20B. The second user 3B is a student of calligraphy. The second user 3B is, for example, a child. The second user 3B faces the display 24 of the terminal apparatus 20B. The second user 3B is taught calligraphy by the first user 3A.

Each of the terminal apparatuses 20 is, for example, a terminal apparatus such as a desktop personal computer (PC), a tablet PC, a notebook PC, or a smartphone.

### (Configuration of Server Apparatus)

As illustrated in FIG. 1, the server apparatus 10 includes a communication interface 11, a memory 12, and a controller 13.

The communication interface 11 is configured to include at least one communication module for connection to the network 2. For example, the communication module is a communication module compliant with a standard such as a wired Local Area Network (LAN) or a wireless LAN. The communication interface 11 is connectable to the network 2 via a wired LAN or a wireless LAN using the communication module.

The memory 12 is configured to include at least one semiconductor memory, at least one magnetic memory, at least one optical memory, or a combination of at least two of these. The memory 12 may function as a main memory, an auxiliary memory, or a cache memory. The memory 12 stores data to be used for operations of the server apparatus 10 and data obtained by the operations of the server apparatus 10.

The controller 13 is configured to include at least one processor, at least one dedicated circuit, or a combination thereof. The processor is, for example, a general purpose processor such as a Central Processing Unit (CPU) or a Graphics Processing Unit (GPU), or a dedicated processor that is dedicated to a specific process. The controller 13 executes processes related to the operations of the server apparatus 10 while controlling the components of the server apparatus 10.

### (Configuration of Terminal Apparatus)

As illustrated in FIG. 1, the terminal apparatus 20 includes a communication interface 21, an input interface 22, an output interface 23, a display 24, a camera 25, a distance measuring sensor 26, and a control apparatus 27.

The communication interface 21 is configured to include at least one communication module for connection to the network 2. For example, the communication module is a communication module compliant with a standard such as a wired LAN standard or a wireless LAN standard, or a mobile communication standard such as the Long Term Evolution (LTE) standard, the 4th Generation (4G) standard, or the 5th Generation (5G) standard.

The input interface 22 is capable of accepting an input from a user. The input interface 22 is configured to include at least one interface for input that is capable of accepting the input from the user. The interface for input is, for example, a physical key, a capacitive key, a pointing device, a touch screen integrally provided with a display of the display 24, a microphone, or the like.

The output interface 23 can output data. The output interface 23 is configured to include at least one interface for output that is capable of outputting the data. The interface for output includes a projector, a speaker, and the like.

The display 24 is capable of displaying data. The display 24 is, for example, a display or the like. The display is, for example, a liquid crystal display (LCD), an organic electro-luminescent (EL) display, or the like.

The camera 25 is capable of imaging subjects to generate captured images. The camera 25 is, for example, a visible light camera. The camera 25 captures continuous images of a subject at any frame rate, for example. Multiple cameras 25 may be disposed around the user.

The distance measuring sensor 26 can generate a distance image of the subject by measuring the distance from the display of the display 24 to the subject. The distance image is an image in which a pixel value of each pixel corresponds to a distance. The distance measuring sensor 26 includes, for example, a Time of Flight (ToF) camera, a Light Detection And Ranging (LiDAR), a stereo camera, or the like.

The control apparatus 27 includes a memory 28 and a controller 29.

The memory 28 is configured to include at least one semiconductor memory, at least one magnetic memory, at least one optical memory, or a combination of at least two of these. The memory 28 may function as a main memory, an auxiliary memory, or a cache memory. The memory 28 stores data to be used for operations of the terminal apparatus 20 and data obtained by the operations of the terminal apparatus 20.

The controller 29 is configured to include at least one processor, at least one dedicated circuit, or a combination thereof. The processor is, for example, a general purpose processor such as a CPU or a GPU, or a dedicated processor that is dedicated to a specific process. The controller 29 executes processes related to the operations of the terminal apparatus 20 while controlling the components of the terminal apparatus 20.

### (Operations of Terminal Apparatus)

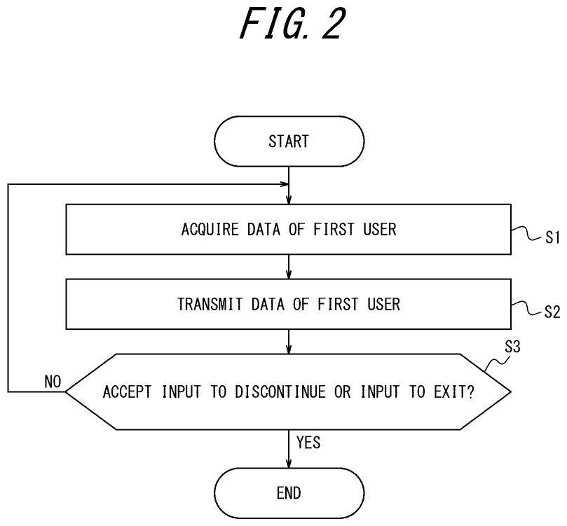

FIG. 2 is a flowchart illustrating an operation procedure of the terminal apparatuses 20 illustrated in FIG. 1. The operation procedure illustrated in FIG. 2 is common to the terminal apparatuses 20A and 20B. In the following description, it is assumed that the terminal apparatus 20A performs the operation procedure illustrated in FIG. 2. When the virtual event starts, the controller 29 begins processing step S1.

In the processing of step S1, the controller 29 acquires data of the first user 3A. The data of the first user 3A includes data of the distance image of the first user 3A, data of the captured image of the first user 3A, data of the surrounding image of the first user 3A, audio data of the first user 3A, and size data of the predetermined body part of the first user 3A. The surrounding image of the first user 3A includes the captured image of the character “Ei” written by the first user 3A, a calligraphy teacher, on a half-sheet of paper as a model. The predetermined body part may be set according to the virtual event, or it may be determined by the teacher, the first user 3A. In the present embodiment, the predetermined body part is the right arm.

In the processing of step S1, the controller 29 acquires the data of the distance image of the first user 3A by controlling the distance measuring sensor 26 to generate the data. The controller 29 acquires the data of the captured images of the first user 3A by controlling the camera 25 to generate the data. The controller 29 acquires the data of the surrounding image of the first user 3A by controlling the camera 25 to generate the data. The controller 29 acquires audio data of the first user 3A by collecting the voice of the first user 3A using a microphone of the input interface 22. The controller 29 acquires the size of the predetermined body part of the first user 3A by analyzing the captured image of the first user 3A.

In the processing of step S2, the controller 29 controls the communication interface 21 to transmit the data of the first user 3A acquired in the processing of step S1 to the server apparatus 10 via the network 2. The data of the first user 3A is transmitted to the terminal apparatus 20B via the server apparatus 10.

In the processing of step S3, the controller 29 determines whether the input interface 22 has accepted an input to discontinue imaging and the like or an input to exit from the virtual event. When it is determined that the input to discontinue imaging and the like or the input to exit from the virtual event has been accepted (step S3: YES), the controller 29 ends the operation procedure as illustrated in FIG. 2. When it is not determined that the input to discontinue imaging and the like or the input to exit from the virtual event has been accepted (step S3: NO), the controller 29 returns to the processing of step S1.

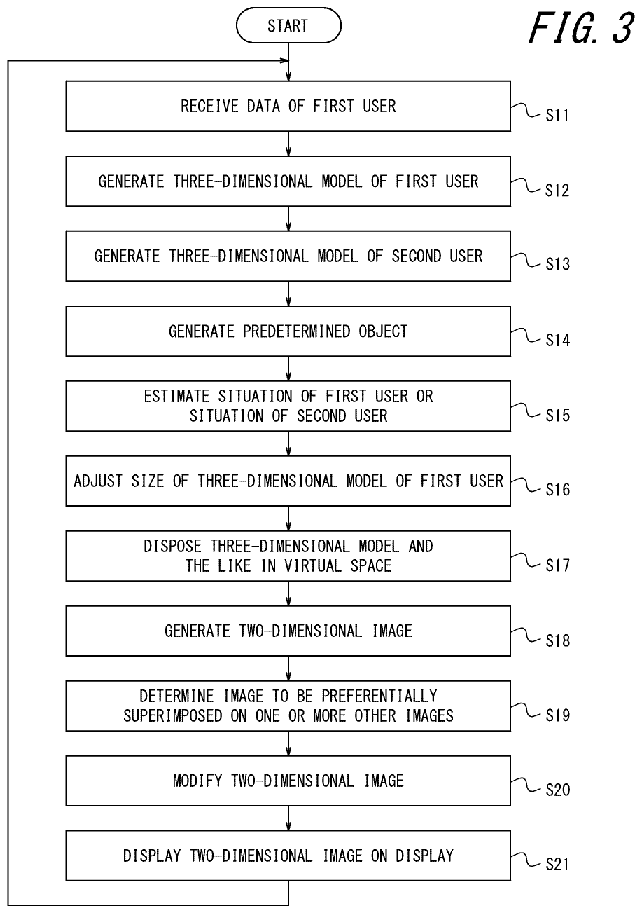

FIG. 3 is a flowchart illustrating an operation procedure of the terminal apparatuses 20 illustrated in FIG. 1. The operation procedure illustrated in FIG. 3 is common to the terminal apparatuses 20A and 20B. The operation procedure illustrated in FIG. 3 is an example of a display method according to the present embodiment. In the following description, it is assumed that the terminal apparatus 20B performs the operation procedure illustrated in FIG. 3.

In the processing of step S11, the controller 29 controls the communication interface 21 to receive the data of the first user 3A from the terminal apparatus 20A via the network 2 and the server apparatus 10.

In the processing of step S12, the controller 29 generates a three-dimensional model of the first user 3A using the data of the first user 3A received in the processing of step S11. For example, the controller 29 generates a polygon model using the data of the distance image of the first user 3A. Furthermore, the controller 29 generates the three-dimensional model of the first user 3A by applying texture mapping to the polygon model using the data of the captured images of the first user 3A.

In the processing of step S13, the controller 29 generates the three-dimensional model of the second user 3B. For example, the controller 29 acquires the data of the distance image of the second user 3B by controlling the distance measuring sensor 26 to generate the data. The controller 29 acquires the data of the captured image of the second user 3B by controlling the camera 25 to generate the data. The controller 29 uses these pieces of data to generate the three-dimensional model of the second user 3B, the same or similar to the process in step S12.

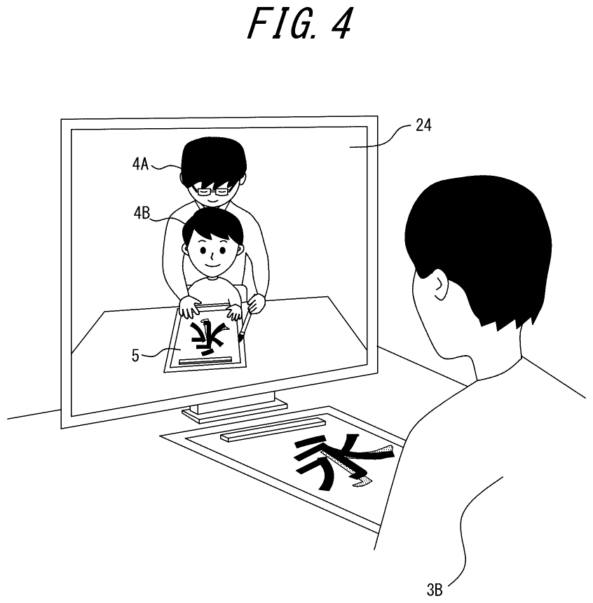

In the processing of step S14, the controller 29 generates the data of the predetermined object. In the present embodiment, the predetermined object is a half sheet of paper as illustrated in FIG. 4 below. However, the predetermined object may be set according to the virtual events. In this predetermined object, a half-sheet of paper, the character “Ei” written by the second user 3B, a calligraphy student, is superimposed on the character “Ei” drawn by the first user 3A, a calligraphy teacher, as a model. First, the controller 29 acquires the data of the captured image of the half sheet of paper in front of the second user 3B by controlling the camera 25 to generate the data. The controller 29 acquires the data of the captured image of the character “Ei” drawn by the first user 3A as a model from the data of the surrounding image of the first user 3A received in the process of step S11. The controller 29 generates the data of the predetermined object by combining the data of the captured image of the half-sheet of paper in front of the second user 3B and the data of the captured image of the character “Ei” drawn by the first user 3A as a model.

In the processing of step S15, the controller 29 estimates the situation of the first user 3A or the situation of the second user 3B. The controller 29 may estimate the situation of the first user 3A by the audio data of the first user 3A or the data of the captured image of the first user 3A received in the process of step S11. The controller 29 may estimate the situation of the second user 3B by the audio data of the second user 3B or the data of the captured image of the second user 3B. The controller 29 acquires the captured image of the second user 3B by the camera 25 as described above. The controller 29 acquires the audio data of the second user 3B by collecting the voice of the second user 3B using the microphone of the input interface 22. The controller 29 may estimate the situation of the first user 3A or the second user 3B by the predetermined keyword included in the audio data of the first user 3A or the second user 3B.

For example, by analyzing the voice data of the first user 3A, the controller 29 estimates that the situation of the first user 3A is a situation in which a posture is being explained. The controller 29 estimates, for example, that the situation of the first user 3A is the situation describing the posture for writing letters.

For example, by analyzing the voice data of the first user 3A, the controller 29 estimates that the situation of the first user 3A is a situation in which the posture of the first user 3A and the posture of the second user 3B are being explained by comparing.

For example, if the controller 29 analyzes the audio data of the first user 3A and detects the keyword “Please look at the half-sheet of paper” as a predetermined keyword in the audio data of the first user 3A, it is estimated that the situation of the first user 3A is a situation in which the predetermined object is being explained.

For example, the controller 29 analyzes the data of the captured mage of the second user 3B and detects the line of sight of the second user 3B to estimate that the situation of the second user 3B is a situation in which the attention of the second user 3B is directed to the predetermined object.

In the processing of step S16, the controller 29 adjusts the size of the three-dimensional model of the first user 3A generated in the processing of step S12. For example, the controller 29 adjusts the three-dimensional model of the first user 3A based on the results of the comparison between the size of the predetermined body part of the first user 3A and the size of the predetermined body part of the second user 3B. As mentioned above, in the present embodiment, the predetermined body part is the right arm. The controller 29 acquires the data on the size of the right arm of the first user 3A from the data of the first user 3A received in the processing of step S11. The controller 29 acquires data on the size of the right arm of the second user 3B by analyzing the captured image of the second user 3B acquired by the camera 25 as described above. For example, assume that the right arm size of the first user 3A is 30 [cm] and the right arm size of the second user 3B is 20 [cm]. In this case, the controller 29 adjusts the size of the three-dimensional model of the first user 3A to be 3/2 times the size of the three-dimensional model of the second user 3B.

In the processing of step S17, the controller 29 disposes the three-dimensional model of the first user 3A, the three-dimensional model of the second user 3B, and the predetermined objects in the virtual space after adjusting their sizes in the processing of step S16.

In the processing of step S17, the controller 29 disposes the three-dimensional model of the first user 3A and the three-dimensional model of the second user 3B based on the reference point. The reference point may be set according to the virtual event, or it may be determined by the teacher, the first user 3A. In the present embodiment, it is the right shoulder. The controller 29 disposes the respective three-dimensional models of the first user 3A and the second user 3B so that the right shoulder of the three-dimensional model of the first user 3A is above the right shoulder of the three-dimensional model of the second user 3B. The controller 29 may move the three-dimensional model of the first user 3A so that the right shoulder of the three-dimensional model of the first user 3A is positioned over the right shoulder of the three-dimensional model of the second user 3B.

In the processing of step S18, the controller 29 renders and generates the two-dimensional image in which the three-dimensional model and the predetermined object disposed in the virtual space are captured from a virtual viewpoint. The virtual viewpoint may be set based on the viewpoint of the second user 3B. For example, the controller 29 sets the virtual line of sight so that the second user 3B and the image 4B of the second user 3B displayed on the display 24 face each other as illustrated in FIG. 4 below. This configuration allows the second user 3B to feel as if he/she is looking at himself/herself through a mirror.

The two-dimensional image generated by the process in step S18 includes an image 4A of the first user 3A, which is a two-dimensional version of the three-dimensional model of the first user 3A, as illustrated in FIG. 4 below. The two-dimensional image also includes an image 4B of the second user 3B, which is a two-dimensional version of the two-dimensional model of the second user 3B, as illustrated in FIG. 4 below. This two-dimensional image also includes an image 5 of the predetermined object, which is a two-dimensional version of the predetermined object, as illustrated in FIG. 4 below.

In the processing of step S19, the controller 29 determines the image to be preferentially superimposed on one or more other images when two or more images out of the image 4A of the first user 3A, the image of 4B of the second user 3B and the image of 5 of the predetermined object overlap. In the present embodiment, the image that is superimposed on top of one or more other images shall be displayed on the front side of the display 24. The controller 29 determines the image to be preferentially superimposed on one or more other images based on the situation of the first user 3A or the situation of the second user 3B estimated in the process of step S15.

For example, assume that two or more overlapping images include the image 4A of the first user 3A. In this case, when the controller 29 estimates in the process of step S15 that the situation of the first user 3A is a situation in which the posture is being explained, the controller 29 determines to superimpose the image 4A of the first user 3A on one or more other images that overlap the image 4A. The controller 29 may determine that in the two or more overlapping images, the image 4A of the first user 3A is the top image. By determining to superimpose the image 4A of the first user 3A on one or more other images, the image 4A of the first user 3A is displayed at the very front of the display 24 of the terminal apparatus 20B when the teacher of calligraphy, the first user 3A, is explaining the posture. By displaying the image 4A of the first user 3A at the very front of the display 24, the possibility of the image 4A of the first user 3A being hidden by other images is reduced. This allows the second user 3B to better observe the posture of the first user 3A.

For example, assume that the two or more overlapping images include the image 4B of the second user 3B. In this case, when the controller 29 estimates in the process of step S15 that the situation of the first user 3A is a situation in which the posture of the first user 3A and the posture of the second user 3B are being explained by comparing, the controller 29 determines that the image 4B of the second user 3B is superimposed on one or more other images that overlap the image 4B. With this configuration, when the teacher, the first user 3A, is comparing and explaining his own posture with that of the second user 3B, the two-dimensional model of the second user 3B is displayed at the very front of the display 24 of the terminal apparatus 20B. By displaying the image 4B of the second user 3B at the very front of the display 24, the possibility of the image 4B of the second user 3B being hidden by other images is reduced. This allows the student, the second user 3B, to listen to the explanation by the first user 3A comparing the posture of the first user 3A with that of the second user 3B, while observing his own posture carefully. The two or more overlapping images may include the image 4A of the first user 3A and the image 5 of the predetermined object in addition to the image 4B of the second user 3B. In this case, the controller 29 may determine to superimpose the image 5 of the predetermined object under the image 4B of the second user 3B and superimpose the image 4A of the first user 3A under the image 5 of the predetermined object. Alternatively, the controller 29 may determine that the image 4B of the second user 3B is superimposed on top, the image 5 of the predetermined object is superimposed second, and the image 4A of the first user 3A is superimposed third.

For example, assume that the image 5 of the predetermined object is included in the two or more overlapping images. In this case, when the controller 29 estimates in the process of step S15 that the situation of the first user 3A is a situation in which the predetermined object is being explained, the controller 29 determines that the image 5 of the predetermined object is superimposed on one or more other images that overlap the image 5. The controller 29 may determine that in the two or more overlapping images, the image 5 of the predetermined object is superimposed on the top. By determining to superimpose the image 5 of the predetermined object on one or more other images, the image 5 of the predetermined object is displayed at the very front of the display 24 of the terminal apparatus 20B when the first user 3A is explaining the text on the half sheet of paper, the predetermined object. By displaying the predetermined object at the very front of the display 24, the possibility of the predetermined object being hidden by other images is reduced. This allows the second user 3B to better observe the predetermined object while listening to the explanation of the first user 3A.

For example, assume that the image 5 of the predetermined object is included in the two or more overlapping images. In this case, when the controller 29 estimates in the process of step S15 that the situation of the second user 3B is a situation in which the attention of the second user 3B is directed to the predetermined object, the controller 29 determines to superimpose the image 5 of the predetermined object on one or more other image that overlap the image 5. The controller 29 may determine that in the two or more overlapping images, the image 5 of the predetermined object is superimposed on the top. By determining to superimpose the image 5 of the predetermined object on the top of the other images, the predetermined object is displayed at the very front of the display 24 of the terminal apparatus 20B when the second user 3B is paying attention to the predetermined object, the text on the half sheet of paper. By displaying the image 5 of the predetermined object at the very front of the display 24, the possibility of the predetermined object being hidden by one or more other images is reduced. This allows the second user 3B to observe the predetermined object better.

In the processing of step S20, the controller 29 modifies the data of the two-dimensional image generated in the processing of step S18 based on the processing result of step S19. In other words, the controller 29 modifies the data of the two-dimensional image so that the image determined to be preferentially superimposed on one or more other images in the process of step S19 is superimposed on one or more other images.

In the processing of step S21, the controller 29 controls the display 24 to display the two-dimensional image modified in step S20. The controller 29 controls the speaker of the output interface 23 to output the audio data of the first user 3A as the voice.

After performing the processing of step S21, the controller 29 returns to the processing of step S11. The controller 29 repeatedly executes the processing of steps S11 to S21 until, for example, the data of the first user 3A is no longer transmitted from the terminal apparatus 20A to the terminal apparatus 20B or the virtual event is terminated.

By executing the processing of steps S11-S21, the display 24 of the terminal apparatus 20B displays, for example, an image 4A of the first user 3A, an image 4B of the second user 3B, and an image 5 of the predetermined object, as illustrated in FIG. 4. In FIG. 4, the two or more overlapping images in the processing of step S19 include the image 4A of the first user 3A and the image 4B of the second user 3B. The controller 29 estimates that the situation of the first user 3A is the situation in which the posture of the first user 3A and the posture of the second user 3B are being explained by comparing in the processing of step S15 and determines that the image 4B of the second user 3B is superimposed on the image 4B in the processing of step S19. As a result of this process, in FIG. 4, the image 4B of the second user 3B is superimposed on the image 4A of the first user 3A. As illustrated in FIG. 4, the display 24 may display the images of objects such as desks in addition to the image 4A.

Here, the two-dimensional image generated in the process of step S18 may include the two-dimensional image generated by the terminal apparatus 20A and the two-dimensional image generated by the terminal apparatus 20B. In this case, the controller 29 of the terminal apparatus 20A may perform the processing of step S19 on the two-dimensional image generated by the terminal apparatus 20A and the two-dimensional image generated by the terminal apparatus 20B. For example, the controller 29 of the terminal apparatus 20A may determine the image to be preferentially superimposed on one or more other images when two or more images out of the two-dimensional image generated by the terminal apparatus 20A and the two-dimensional image generated by the terminal apparatus 20B overlap.

Thus, in the terminal apparatus 20B, the controller 29 determines the image to be preferentially superimposed on one or more other images when two or more images out of the image 4A of the first user 3A, the image 4B of the second user 3B, and the image 5 of the predetermined object are superimposed and displayed on the display 24. The controller 29 determines the image to be preferentially superimposed based on the situation of the first user 3A or the situation of the second user 3B. User convenience can be improved by determining the image to be preferentially superimposed based on the situation of the first user 3A or the situation of the second user 3B.

Here, when disposing the three-dimensional model of the first user 3A and the three-dimensional model of the second user 3B in the virtual space in the processing of step S17, the placement positions of the three-dimensional models of the first user 3A and the second user 3B may be close. For example, if the first user 3A writes a model from behind the second user 3B in a virtual event that is a calligraphy as illustrated in FIG. 4, the placement positions of the three-dimensional models of the first user 3A and the second user 3B are close. In this case, the part of the image 4A of the first user 3A may be hidden by the image 4B of the second user 3B, or part of the image 4B of the second user 3B may be hidden by the image 4A of the first user 3A in the two-dimensional image generated by the process in step S18. In addition, because the part of the half sheet of paper is hidden by the hand of the second user 3B, the part of the image 5 of the predetermined object may be hidden by the image 4B of the second user 3B in the two-dimensional image generated by the process in step S18. Thus, even if a portion of images 4A, 4B, and 5 are hidden, the possibility of a portion of images 4A, 4B, and 5 being hidden on the display 24 is reduced by determining the image to be preferentially superimposed in the process of step S19.

Thus, according to the present embodiment, improved technology for generating a video in which multiple images are superimposed can be provided.

For example, if the first user 3A is an adult and the second user 3B is a child, the body size of the first user 3A, the teacher, and the body size of the second user 3B, the student, may differ significantly. The position of the first user 3A relative to the display 24 of the terminal apparatus 20A and the position of the second user 3B relative to the display 24 of the terminal apparatus 20B may differ. In this case, if the three-dimensional models of the first user 3A and the second user 3B are simply disposed in the virtual space, the second user 3B may not be able to model the posture, etc. of the first user 3A by looking at the image displayed on the display 24. In the present embodiment, the process in step S16 results in a size ratio between the three-dimensional model of the first user 3A and the three-dimensional model of the second user 3B that is similar to the size ratio between the body of the first user 3A and the body of the second user 3B. In the processing of step S17, the controller 29 disposes the three-dimensional model of the first user 3A and the three-dimensional model of the second user 3B based on the reference point. With this configuration, the second user 3B can correctly compare his/her own posture with that of the first user 3A by viewing the two-dimensional image displayed on the display 24 of the terminal apparatus 20B by the process of step S21. In other words, the second user 3B can use the posture of the first user 3A as an example.

Hereinafter, variations of the present embodiment will be described.

In the processing of step S21 described above, the controller 29 may have the projector of the output interface 23 project the character “Ei” from the example of the first user 3A onto the actual half-sheet of paper as illustrated in FIG. 4.

When repeatedly executing the process of steps S11-S21 above, the controller 29 may execute the process of step S16 when the predetermined trigger is detected. The predetermined trigger is, for example, an input by the second user 3B to the input interface 22 of the terminal apparatus 20B, a predetermined action of the second user, or a predetermined keyword such as “Please pay attention to your posture”. The predetermined keyword may be set by the first user 3A. The predetermined actions of the second user include, for example, holding a brush, the second user 3B's gaze meeting the gaze of the first user 3A whose gaze is displayed as the image 4A on the display 24 of the terminal apparatus 20B, and so on. By executing step S16 when the predetermined trigger is detected, the size of the three-dimensional model of the first user 3A is adjusted at the timing when the second user 3B wants to see the posture of the first user 3A as an example.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in the embodiment described above, the terminal apparatus 20A and the terminal apparatus 20B are described as performing the virtual event via the server apparatus 10. However, the terminal apparatus 20A and the terminal apparatus 20B may perform the virtual event without through the server apparatus 10. As an example, the terminal apparatus 20A and the terminal apparatus 20B may perform the virtual event while being connected in a Peer to Peer (P2P) architecture.

For example, the embodiments described above are described as providing lessons learned by providing virtual events. However, by offering virtual events, other practices such as flower arrangement or ceramics may be offered. In the case of flower arrangement, the predetermined object may be a flower. In the case of ceramics, the predetermined object may be ceramics, etc.

Examples of some embodiments of the present disclosure are described below. However, it should be noted that the embodiments of the present disclosure are not limited to these.

[Appendix 1] A control apparatus comprising a controller configured to determine an image to be preferentially superimposed on one or more other images, based on a situation of a first user or a situation of a second user facing a display, when two or more images out of an image of the first user, an image of the second user, and an image of a predetermined object are superimposed and displayed on the display.

[Appendix 2] The control apparatus according to appendix 1, wherein the controller is configured to determine to superimpose the image of the first user on one or more other images that overlap the image of the first user when the situation of the first user is estimated to be a situation in which a posture is being explained, in a case in which the image of the first user is included in the two or more images.

[Appendix 3] The control apparatus according to appendix 1 or 2, wherein the controller is configured to determine to superimpose the image of the second user on one or more other images that overlap the image of the second user when the situation of the first user is estimated to be a situation in which a posture of the first user and a posture of the second user are being explained by comparing, in a case in which the image of the second user is included in the two or more images.

[Appendix 4] The control apparatus according to any one of appendices 1 to 3, wherein the controller is configured to determine to superimpose the image of the predetermined object under the image of the second user and superimpose the image of the first user under the image of the predetermined object in a case in which the image of the first user and the image of the predetermined object are included in addition to the image of the second user in the two or more images.

[Appendix 5] The control apparatus according to any one of appendices 1 to 4, wherein the controller is configured to determine to superimpose the image of the predetermined object on one or more other images that overlap the image of the predetermined object when the situation of the first user is estimated to be a situation in which the predetermined object is being explained, in a case in which the image of the predetermined object is included in the two or more images.

[Appendix 6] The control apparatus according to any one of appendices 1 to 5, wherein the controller is configured to determine to superimpose the image of the predetermined object on one or more other images that overlap the image of the predetermined object when the situation of the second user is estimated to be a situation in which attention of the second user is directed to the predetermined object, in a case in which the image of the predetermined object is included in the two or more images.

[Appendix 7] The control apparatus according to any one of appendices 1 to 6, wherein the controller is configured to estimate the situation of the first user or the situation of the second user based on audio data of the first user or audio data of the second user.

[Appendix 8] The control apparatus according to any one of appendices 1 to 7, wherein the controller is configured to estimate the situation of the first user or the situation of the second user based on a predetermined keyword included in audio data of the first user or audio data of the second data.

[Appendix 9] A terminal apparatus comprising:
a display; and
a controller configured to determine an image to be preferentially superimposed on one or more other images, based on a situation of a first user or a situation of a second user facing the display, when two or more images out of an image of the first user, an image of the second user, and an image of a predetermined object are superimposed and displayed on the display.

[Appendix 10] A display method comprising determining an image to be preferentially superimposed on one or more other images, based on a situation of a first user or a situation of a second user facing a display, when two or more images out of an image of the first user, an image of the second user, and an image of a predetermined object are superimposed and displayed on the display.

1. A control apparatus comprising a controller configured to determine an image to be preferentially superimposed on one or more other images, based on a situation of a first user or a situation of a second user facing a display, when two or more images out of an image of the first user, an image of the second user, and an image of a predetermined object are superimposed and displayed on the display.

2. The control apparatus according to claim 1, wherein the controller is configured to determine to superimpose the image of the first user on one or more other images that overlap the image of the first user when the situation of the first user is estimated to be a situation in which a posture is being explained, in a case in which the image of the first user is included in the two or more images.

3. The control apparatus according to claim 1, wherein the controller is configured to determine to superimpose the image of the second user on one or more other images that overlap the image of the second user when the situation of the first user is estimated to be a situation in which a posture of the first user and a posture of the second user are being explained by comparing, in a case in which the image of the second user is included in the two or more images.

4. The control apparatus according to claim 3, wherein the controller is configured to determine to superimpose the image of the predetermined object under the image of the second user and superimpose the image of the first user under the image of the predetermined object in a case in which the image of the first user and the image of the predetermined object are included in addition to the image of the second user in the two or more images.

5. The control apparatus according to claim 1, wherein the controller is configured to determine to superimpose the image of the predetermined object on one or more other images that overlap the image of the predetermined object when the situation of the first user is estimated to be a situation in which the predetermined object is being explained, in a case in which the image of the predetermined object is included in the two or more images.
